(19) United States
(12) Patent Application Publication
(10) Pub. No.: US 2007/0217199 A1
(43) Pub. Date: Sep. 20, 2007

(54) Light-based dermal enhancing apparatus and methods of use

(75) Inventors: Horst Adam, San Mateo, CA (US); Victor C. Esch, Albuquerque, NM (US); Marc P. Maisel, Los Altos, CA (US); Joseph Robert Rimsa, Palo Alto, CA (US)

Correspondence Address: PAUL, HASTINGS, JANOFSKY & WALKER LLP, P.O. BOX 919092, SAN DIEGO, CA, 92191-9092, US

(73) Assignee: Light Dimensions, Inc.

(21) Appl. No.: 11/549,524

(22) Filed: Oct. 13, 2006

Related U.S. Application Data
(60) Provisional application No. 60/783,808, filed on Mar. 17, 2006.
(60) Provisional application No. 60/822,915, filed on Aug. 18, 2006.

(51) Int. Cl. F21V 23/04

(52) U.S. Cl. 362/276

(57) ABSTRACT

Embodiments are described for a light-based dermal enhancing apparatus and methods of use. In general, the dermal enhancing apparatus includes elongated housing having opposite top and bottom ends. The housing has a translucent outer shell that defines a translucent window at the top end of the housing that is capable of permitting passage of light therethrough from one or more treatment light emitting diodes (LEDs) located in the housing. The housing may also include an inner shell that provides an interior cavity in which the interior components of the dermal enhancing apparatus are located. In addition to the treatment LEDs, a tube with a reflective lumen is located in the housing to afford a passage between the window and the LEDs. In some embodiments, the outer shell may have an elongated indicator guide that extends from the translucent window towards the bottom end of the housing so that refracted light from the light passing through the window illuminates the indicator guide.

### CROSS-REFERENCES TO RELATED APPLICATIONS

This application claims benefit to U.S. Provisional Application Ser. No. 60/783,808, filed Mar. 17, 2006 and to U.S. Provisional Application Ser. No. 60/822,915, filed Aug. 18, 2006, both of which are hereby incorporated by reference herein in their entirety, and also claims benefit to U.S. Provisional Application Ser. No. 60/822,904, filed Aug. 18, 2006.

### TECHNICAL FIELD

Embodiments described herein relate generally to skin treatment devices and more particular to devices that use light or radiation to provide a dermatological treatment to the skin of a user.

### BACKGROUND

It is known that exposing skin and other living tissue to light (i.e., electromagnetic radiation) can have therapeutic and healing value. By exposing skin to various wavelengths of light for a period of time, the skin and associated tissues can experience beneficial effects. Various treatments can be performed using light to reduce the effects of acne, for scar reduction, tissue rejuvenation and for wrinkle reduction.

### SUMMARY

Embodiments are described for a light-based dermal enhancing apparatus and methods of use. In general, the dermal enhancing apparatus includes elongated housing having opposite top and bottom ends. The housing has a translucent outer shell that defines a translucent window at the top end of the housing that is capable of permitting passage of light therethrough from one or more treatment light emitting diodes (LEDs) located in the housing. The housing may also include an inner shell that provides an interior cavity in which the interior components of the dermal enhancing apparatus are located. In addition to the treatment LEDs, a tube with a reflective lumen is located in the housing to afford a passage between the window and the LEDs. In some embodiments, the outer shell may have an elongated indicator guide that extends from the translucent window towards the bottom end of the housing so that refracted light from the light passing through the window illuminates the indicator guide.

A motor may be provided in the housing to provide a vibrating massage motion for the dermal enhancing apparatus. An actuator on the exterior of the housing can be provided to control the activation of the treatment LEDs, the sequence in which the LEDs are activated as well as control activation of the motor. As an added safety feature, a proximity sensor may be provided in the housing for detecting when the window is close (i.e., proximate) to a surface such as the skin of a user. The treatment LEDs may also be controlled so that they emit light once the proximity sensor detects a surface within a predefined distance from the window.

The actuator may have a visual treatment indicator located nearby to provide a visual indication of the selection of the treatment LEDs by the actuator and/or to provide a visual indication of when the treatment LEDs are activated. In one embodiment the visual treatment indicator can be an illuminated ring extending around the actuating portion of the actuator. In one embodiment, the visual treatment indicator may provide a visual indication of the color of the light being emitted by light source. In another embodiment, the visual treatment indicator may provide a visual indication of the color of the light being emitted by light source before the light source is activated to emit light.

In one embodiment, the window can be optically clear. In one embodiment, optically clear may be defined as a transparent media that provides for substantially undistorted and nonabsorbing transmission of light rays. In another embodiment, the window can be frosted so that it is translucent and thereby helps diffuse the light from the treatment LEDs passing through the window.

In one embodiment, a heat sink may be provided inside the housing to help dissipate heat generated by components inside the housing.

In one embodiment, the treatment LEDs may include at least one LED capable of emitting a red light. In another embodiment, the treatment LEDs may include at least one LED capable of emitting a blue light. In a further embodiment, the plurality of LEDs may include at least one LED capable of emitting infrared light.

The dermal apparatus may include a battery power supply contained in the housing. In one such embodiment, an inductive charging coil may be provided in the housing for recharging the battery power supply. In one such embodiment, the dermal apparatus may have a charging base that has a cavity for receiving a portion of the housing therein. The charging base may include circuitry for inductively coupling the inductive charging coil of the dermal apparatus to an external power supply in order to recharge the battery.

### BRIEF DESCRIPTION OF THE DRAWINGS

FIG. 1 is a schematic perspective view of an exemplary light-based dermal enhancing apparatus in accordance with one embodiment;

FIG. 2 is a schematic side view of an exemplary light-based dermal enhancing apparatus in accordance with one embodiment;

FIG. 3 is a schematic cross sectional view of an exemplary light-based dermal enhancing apparatus with an illustrative parts list;

FIG. 4 is an exploded schematic view of an embodiment of a light-based dermal enhancing apparatus;

FIG. 5 is a schematic perspective view of an exemplary frame subassembly of a light-based dermal enhancing apparatus;

FIG. 6 is an illustrative block diagram of various functional components of an exemplary light-based dermal enhancing apparatus in accordance with an embodiment;

FIG. 7 is an exemplary electrical circuit diagram of an embodiment of a light-based dermal enhancing apparatus;

FIG. 8 is a close up view of a light emitting optical end region of a light-based dermal enhancing apparatus in accordance with an embodiment;

FIG. 9 is a schematic plan view of an exemplary housing of a light emitting optical end region of a light-based dermal enhancing apparatus in accordance with an embodiment;

FIG. 10 is a cross sectional view of an exemplary housing of a light emitting end region of a light-based dermal enhancing apparatus taken from perspective of line A-A of FIG. 9;

FIG. 11 is an end view of an exemplary light emitting end region of a light-based dermal enhancing apparatus in accordance with an embodiment;

FIG. 12 is a cross sectional view of the area around the angled tip of the outer shell of the upper housing illustrating an interior view of the angled tip of an exemplary light light-based dermal enhancing apparatus in accordance with an embodiment;

FIG. 13 is a cross sectional view of the area around the angled tip of the outer shell of the upper housing taken from a plane parallel to a longitudinal axis of an exemplary light-based dermal enhancing apparatus in accordance with an embodiment;

FIG. 14 is a schematic perspective view of an embodiment of a light-based dermal enhancing apparatus in a charging base;

FIG. 15 is a schematic partial cross-section of an exemplary charging base of a light-based dermal enhancing apparatus in accordance with an embodiment;

FIG. 16 is a schematic perspective view of an embodiment of a light-based dermal enhancing apparatus in a charging base showing the bottom of the charging base;

FIG. 17 is a block diagram of an illustrative embodiment of a charger circuit of a light-based dermal enhancing apparatus;

FIG. 18 is an exemplary functional stack identifying the various conceptual modules that may be programmed into the processor;

FIG. 19 is a flowchart of an exemplary treatment process that may be carried out by the processor in accordance with an exemplary embodiment;

FIG. 20 is an axial cross section of a pleated implementation of the optical tube;

FIG. 21 is an cross section of a pleated implementation of the optical tube in accordance with one embodiment.

FIG. 22 is side view of an embodiment of a pleated implementation of the optical tube with upwardly tapering pleats; and

FIG. 23 is an cross sectional view taken from line A-A of FIG. 22.

### DETAILED DESCRIPTION

Embodiments are described for a light-based dermal enhancing apparatus and methods of use. The light-based dermal enhancing apparatus (also referred to herein as “dermal apparatus”) may be used to provide light-based skin treatments to users. In one embodiment, the dermal apparatus may comprise a wand-shaped hand-held device that a user can use virtually anywhere on the body. A charging base may accompany the dermal apparatus as a means for recharging a rechargeable-type battery power supply contained in the apparatus. The dermal apparatus is generally configured to deliver timed light treatments at various power densities in order to achieve clinically-determined doses. Embodiments of the dermal apparatus can be implemented with various high-power, light emitting diodes that are capable of generating a relatively narrow spectrum of wavelengths clinically determined for use with different skin conditions.

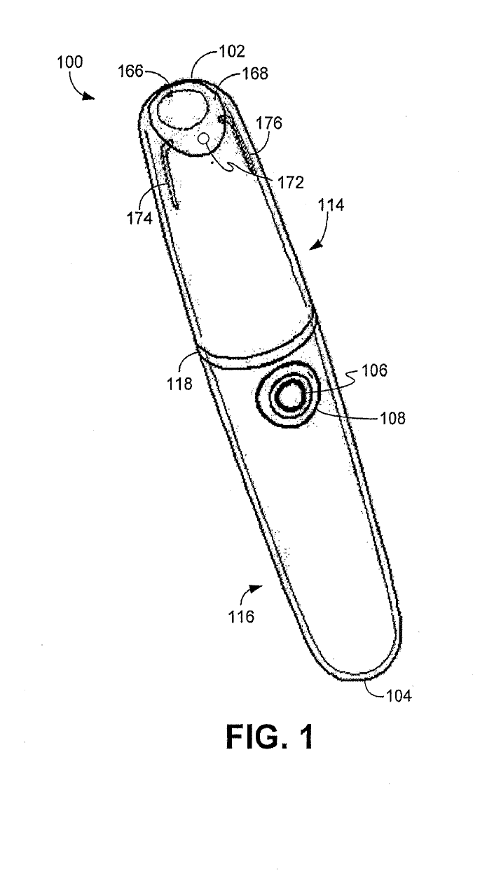

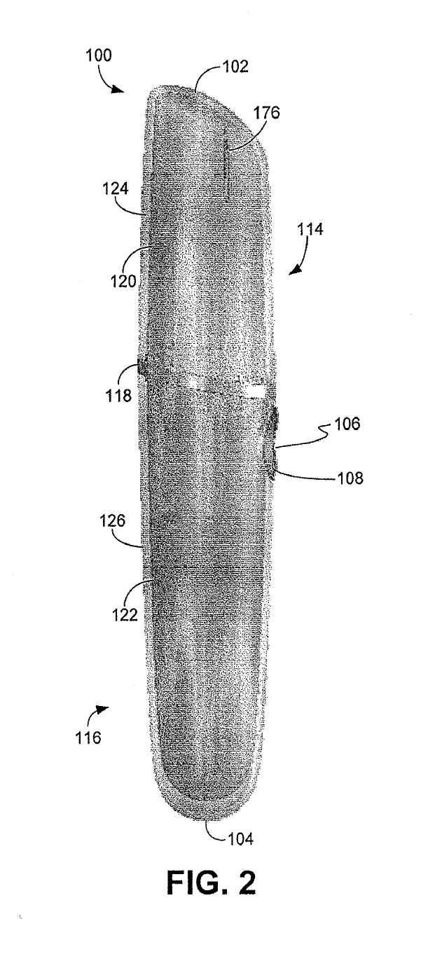

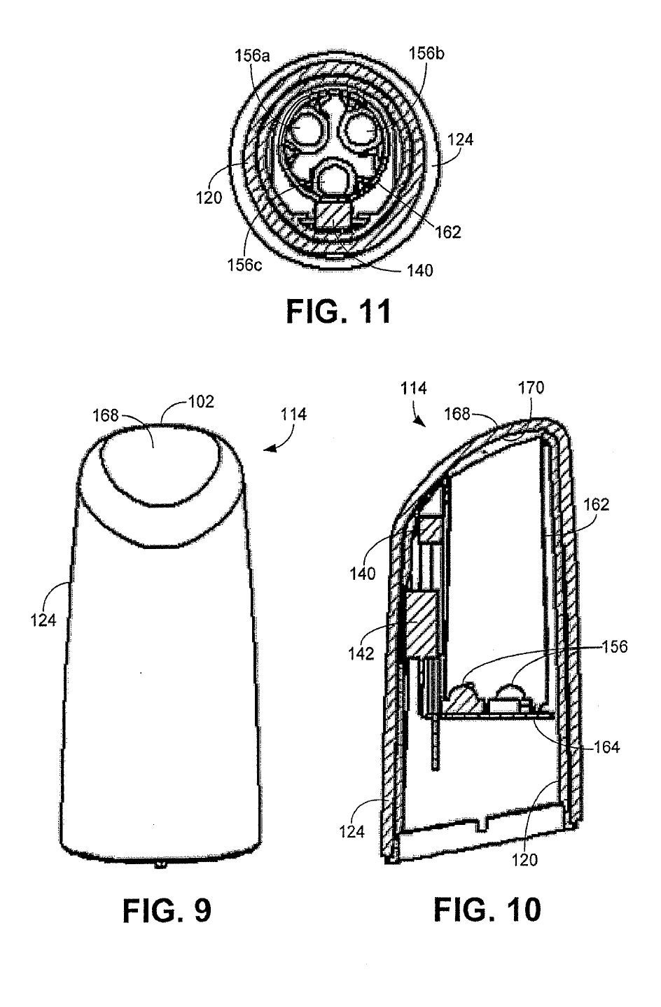

An exemplary embodiment of a light-based dermal enhancing apparatus 100 is depicted with reference to FIGS. 1-21. With particular reference to FIGS. 1 and 2, the body of the dermal apparatus 100 is elongated and generally sized to be grasped by the hand of a user. One end 102 of the dermal apparatus 100 may be designated as the optical or light emitting end while the opposite end 104 of the dermal apparatus 100 may be designated as the charging end. For ease of description, the optical end 102 may also be referred to the top or upper end of the dermal apparatus 100 while the charging end 104 may be referred to as the bottom or lower end of the dermal apparatus 100. The optical end 102 of the dermal apparatus may form an angled tip through which treatment light can be emitted from the dermal apparatus 100. In one embodiment, the angled tip of the optical end 102 of the dermal may have a rounded peripheral edge.

A control actuator 106 such as a depressible button or some sort of actuating switch may be provided on the side of the dermal apparatus 100. As shown in the drawings, the actuating portion of the control actuator 106 can be circular or disk-shaped. In one embodiment, the control actuator 106 may be positioned between the top and bottom ends 102, 104 of the dermal apparatus so that when the dermal apparatus 100 is held by a user, the user's thumb (or other digit) can be conveniently positioned over an actuating portion of the actuator 106 for easier use.

In one embodiment, the control actuator 106 and a lower region of the peripheral edge of the angled tip/optical end 102 may be orientated along a common line parallel to the longitudinal axis of the dermal apparatus.

The body of the dermal apparatus 100 may also include a treatment indicator 108 that can provide a visual indication of the configuration or state in which the dermal apparatus 100 is in or configuration/state the dermal apparatus is about to be in. As depicted in illustrative embodiment, the treatment indicator 108 can be ring-shaped (i.e., annular) and extend around the actuating portion of the control actuator 106.

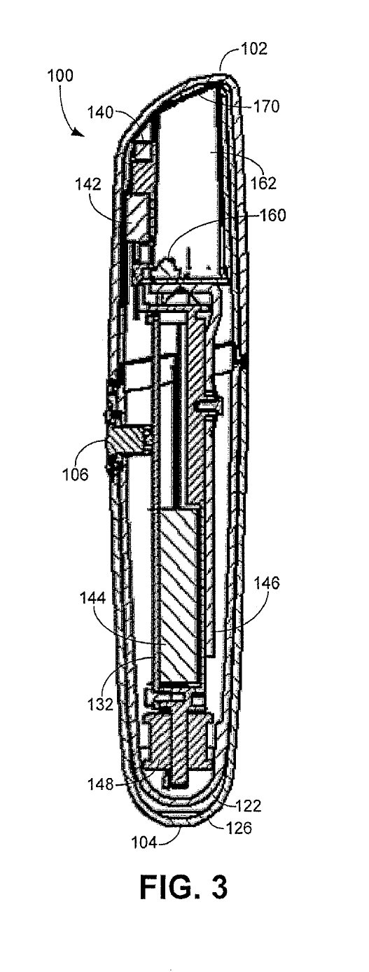

As best shown with reference to FIGS. 3-5, an exemplary embodiment of the dermal apparatus 100 may be constructed from two general parts: (1) an outside enclosure 110 (or “housing”) that contains (2) an internal frame assembly (or “frame”) 112.

### Housing

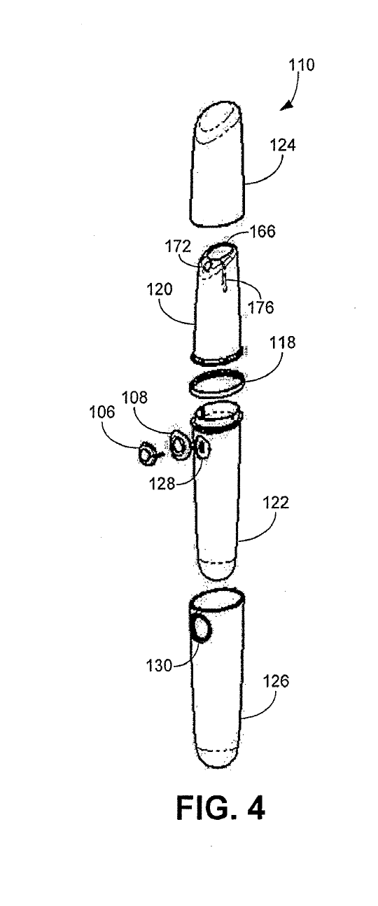

The housing 110 defines the exterior of the dermal apparatus 100 and defines an interior cavity for containing the internal frame 112. FIG. 4 shows an exploded view of an exemplary housing 110. As shown, the housing 110 can be broken up into upper and lower portions 114, 116 and a trim ring 118.

Each portion 114, 116 of the housing can comprise a protective inner shell 120, 122 and a transparent or translucent outer shell 124, 126. The inner and outer shells 120, 122, 124, 126 can also be referred to an inner and outer housings respectively. The inner shells 120, 122 are shaped so that each can be nested in its respective outer shell 124, 126. When the housing 110 is assembled, the inner shells 120, 122 define the interior space of the housing. In a preferred embodiment, the inner and outer shells 120, 122, 124, 126 are made from plastic materials with the inner shells 120, 122 being made of a generally opaque plastic material and the outer shells 124, 126 being made from a transparent or translucent plastic material.

When the housing 110 is assembled, the inner shells 122, 124 are located inside their respective outer shell 126,38 and with the open ends of the upper and lower portions 114, 116 coupled together. The trim ring 118 may be located in a joint region where these two portions 114, 116 meet. The upper and lower portions 114, 116 of the housing can be coupled together in a manner that prevents liquids from passing into the housing where the two portions meet (e.g., using a glue or adhesive or by fusing the portions together).

In one embodiment, the control actuator 106 and treatment indicator 108 may be located in the lower portion 116 of the housing. As shown in the exemplary embodiment depicted in FIG. 4, the inner and outer shells 122, 126 of the lower portion of the housing may each have a side opening 128, 130 in which at least the actuating portion of the control actuator 106 can be located when the dermal apparatus 100 is assembled. As an option, a one-way seal may be provided between the actuating portion of the control actuator 106 and the peripheries of these side holes 128, 130 into order to provide a selective passage through the housing through which air and moisture can escape from the interior of the housing. Such as seal can be designed to be sufficiently robust in order to prevent water and other moisture from getting into the interior of the housing from the exterior (e.g., from a splash or accidental dunking of the dermal apparatus).

### Frame

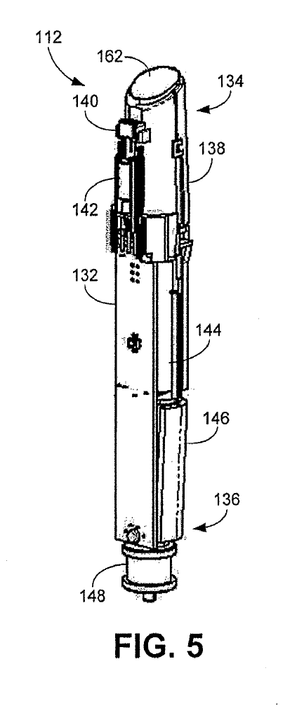

FIG. 5 depicts an illustrative frame 112 that can be contained in the housing 110. In the illustrative embodiment shown in FIG. 5, the frame 112 can be built around a main printed circuit board (PCB) 132 containing at least a portion of the circuitry for controlling and operating the dermal apparatus 100 and to which other components can be mounted. These components may include, for example, an optical or operating sub-assembly 134 located towards an upper end of the main PCB 132 and a battery sub-assembly 136 located towards a lower end of the main PCB 132. In an illustrative embodiment, the optical sub-assembly 136 may include an optical component 138, a proximity sensor 140 (also referred to as a “face sensor”) and a vibrating motor 142. The battery sub-assembly 136 may include a battery power supply 144, a heat sink 146 and an inductive recharging coil 148. When the dermal apparatus 100 is assembled, the frame 112 is located inside the interior cavity defined by the inner portions 120, 122 of the housing 110 with the optical sub-assembly 134 orientated towards the top end 102 of the body of the dermal apparition 100 and the battery sub-assembly 136 orientated towards the bottom end 104 of the body.

### Functional Components

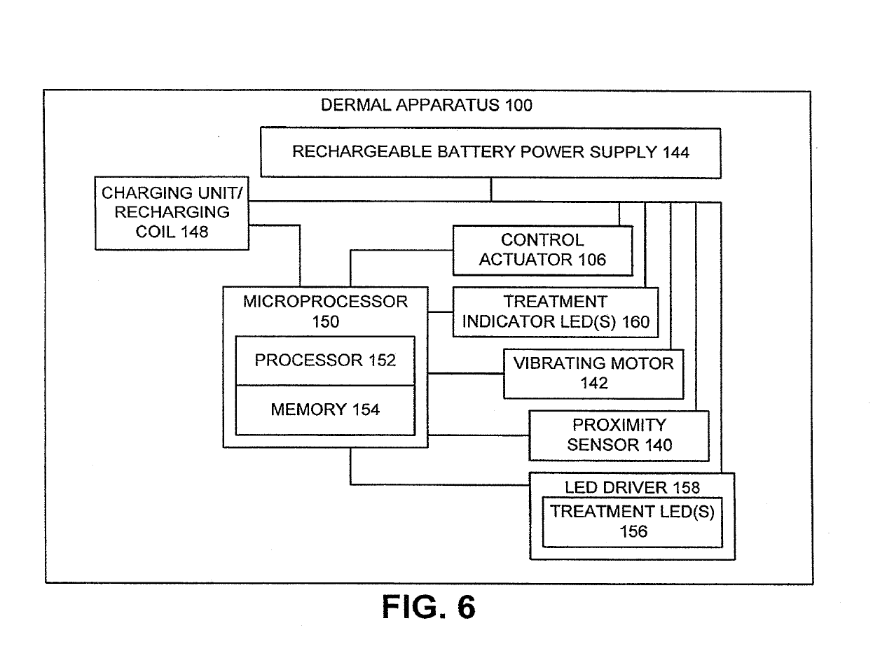

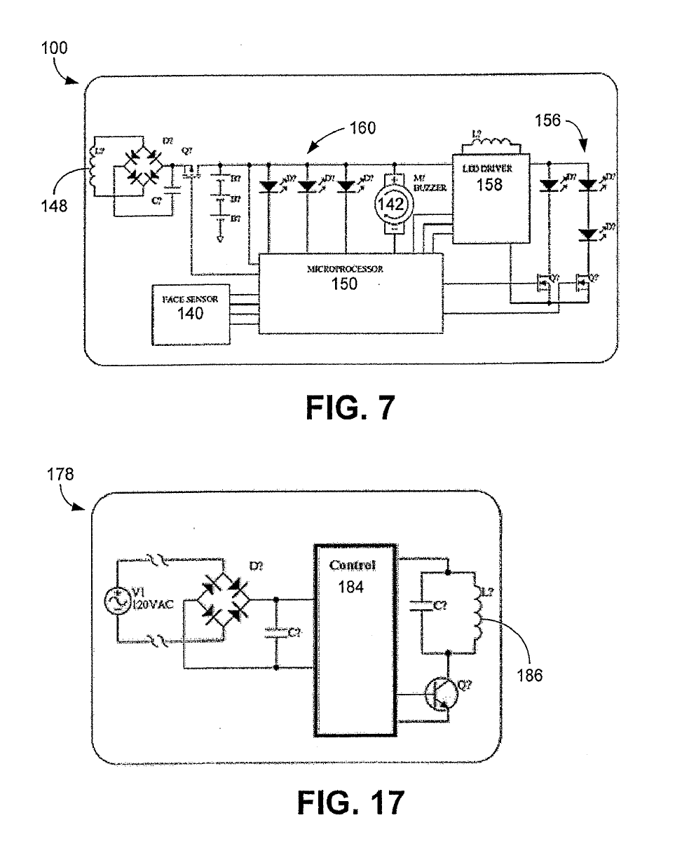

FIG. 6 depicts the various functional components of an illustrative dermal apparatus 100 (an exemplary circuit diagram for some of these components is shown in FIG. 7). A rechargeable battery power supply 144 provides power to the various components shown in FIG. 6 while a microprocessor unit 150 controls operation of the various components and features of the dermal apparatus 100.

The microprocessor unit 150 may include a processor 152 and memory 154. Some or all of the microprocessor's functionality for controlling the various components and features of the dermal apparatus may be programmed into the processor 152 using software that can be stores in the memory 154. In one embodiment, the memory 154 can comprise a non-volatile flash-type memory.

An inductive charging unit 148 is provided for recharging the battery power supply and includes the recharging coil for inductive recharging of the battery from an external power source.

Control actuator 106 permits manual control of the microprocessor 150 and thereby can be used to control operation of the other components via the microprocessor 150.

A proximity sensor 140 (also referred to as the “face sensor”) may be provided to also control the microprocessor 150. In one embodiment, the proximity sensor 140 may comprise a IR transceiver that transmits IR signals/waves and receives reflections from these IR signals to calculate its proximity to the surface from which these signals were reflected.

One or more treatment light sources 156 (e.g., LEDs) may be operated via a light source driver 158 (“LED driver”) under the control of the microprocessor 150. When activated, the light source driver 158 can cause the illumination of one or more of treatment light sources 156 included in the optical sub-assembly 134. In one embodiment, the LED driver is located on the PCB 132.

One or more treatment indicator light sources 160 (“treatment indicator LEDs’) may also be provided to provide light for the treatment indicator 108. A vibrating motor 142 that vibrates when activated may also be included to provide a vibrating massage effect when using the dermal apparatus 100. As mentioned previously, the microprocessor 150 may be coupled to these components in order to control them.

The heat sink 146 can comprise a metal structure coupled to the main PCB 132 and/or recharging coil/inductive recharging unit 148 to conduct heat away from the various components of the frame 112. In one embodiment, the heat sink 146 may made of aluminum.

### Optical End

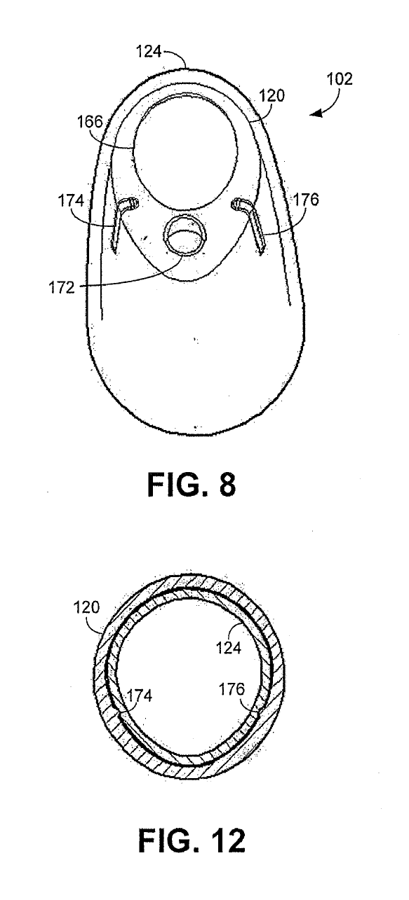

With particular reference to FIGS. 8-11, the optical sub-assembly 134 is positioned inside the housing towards optical end 102 of the dermal apparatus 100. The optical sub-assembly 134 includes an open ended optical tube 162 with the treatment light sources 156 located at a bottom end of the optical tube 162. In one embodiment, the light sources 156, and bottom end of the optical tube 162 may be mounted on a PCB 164 to hold these components in place with respect to one another (see FIG. 3).

The top end of the optical tube 162 is positioned adjacent the angled tip 12 of the dermal apparatus 100 and may be angled at an angle similar or the same as the angled tip. The inner shell 120 of the upper housing 114 may have an opening 166 through which the top end of the tube 162 extends so that the top end can abut (or at least be adjacent to) an interior surface of the angled tip region of the outer shell 124 of the upper portion 114 of the housing.

The treatment light sources 156 can comprise one or more light sources (e.g., treatment light sources 156a, 156b, 156c). In one embodiment, each treatment light source 156 can comprise a light emitting diode (LED). Activation and deactivation of the treatment light sources can be controlled by the microprocessor 150 via the treatment light source driver 158.

The color and specific wavelength of each treatment light source 156 can depend of the particular treatment properties of a given light wavelength. For example, in one embodiment for providing a revitalizing skin treatment (also referred to as the “revitalizer” or “revitalizing embodiment”), the treatment light sources 156 may comprise two infrared (IR) light sources and a red light source (e.g., two IR LEDs and one red light LED). In another embodiment for providing a light treatment for preventing and/or reducing the effects of acne (also referred to as the “acne treatment”), the treatment light sources 156 may comprise a red light source and a blue light source (e.g., a red light LED and a blue light LED). FIG. 11 depicts an exemplary arrangement of the treatment light sources 156a, 156b, 156c for the revitalizing and acne embodiments in accordance with a preferred embodiment (with, for example, the upper two light sources 156a, 156b being provided in the acne treatment embodiment). Table 1 sets forth wavelengths for the various treatment light sources in accordance with a preferred embodiment. Table 1 also sets forth preferred energy levels for these light sources.

TABLE 1

| | |
|---|---|
| Wavelength | |
| Acne LEDs: | |
| Red | 627 nm peak wavelength |
| Blue | 460 nm peak wavelength |
| Revitalizer: | |
| Red | 627 nm peak wavelength |
| IR | 850 nm peak wavelength |
| Energy | |
| Acne LEDs: | |
| Red | <12 J/cm² |
| Blue | <12 J/cm² |
| Revitalizer: | |
| Red | <12 J/cm² |
| IR | <12 J/cm² |
| Emitting area | 3.22 cm² |
| Treatment time | ≦5 minutes |
| (for all wavelengths both for | |
| revitalizer and acne) | |

The top end of the optical tube 162 may provide an area that can be illuminated by the treatment light sources between 1 cm² and 5 cm². In a preferred embodiment, the treatment area that can be illuminated by the light sources 156 through the top end of the optical tube 162 is 3.22 cm² (see Table 1). The lumen of the optical tube 162 may also comprise a reflective surface to permit reflecting of the light from the treatment light sources 156.

With reference to FIGS. 8-13, the angled tip/top end 102 of the outer shell 124 of the upper housing 114 forms an output window through which light from the treatment light sources 156 can shine through. In one embodiment, an area 168 of the angled tip/output window 102 of the outer shell 124 located over the emitting area of the optical unit 134 may be frosted or made to scatter light so that light from the treatment light is more diffused. This frosted area 168 may also be referred to as the diffuse zone. The diffuse zone 168 is scattering in order to help to homogenize the light output from the optical end 12 of the housing, spreading the light output into a larger angular spread, or beam, to help to ensure that the light output from the optical end 102 is at an eye-safe output level. It also provides for an extended source such that the eye images the large source of the diffuse zone, and not the small source of the LED, thus ensuring eye safety. In one embodiment, the diffuse zone 168 of the angled tip/output window may be formed from a roughened interior surface 170 of the angled tip region 102 of the outer shell 124 of the upper housing. The roughened surface 170 may be formed, for example, during the molding process of the outer shell (i.e., provided on the mold used to create the outer shell) or even by roughening up (e.g., scratching or etching) the interior surface. As an alternative to roughening up the interior surface, a translucent film can be applied to the interior surface to create the diffuse zone.

By placing the diffuse zone on the interior side of the window the optical characteristic of the scattering surface is not affected by contact with the skin, or the application of, or contact with, fluids, such as lotions.

In use, light emitting from the treatment light sources 156 may be guided through the output window formed in the upper outer housing 124 via the optical tube 162. The interior reflective surface of the optical tube 162 (in additional to the scattering diffuse area of the output window) acts to homogenize the light distribution incident upon the diffuse zone, providing a uniform light distribution at the surface to be treated. By ensuring that no hot-spots exist it also ensures eye safe levels are achieved.

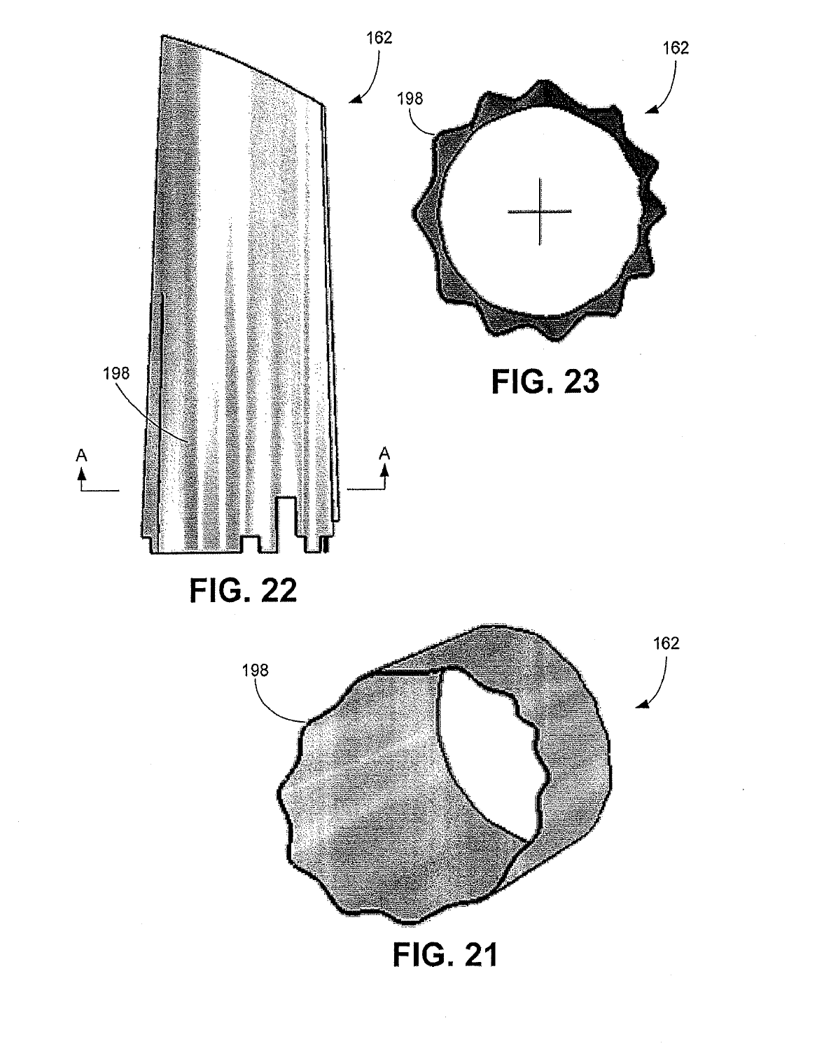

With reference to FIGS. 20-23, the surface of the lumen of the optical tube 162 may include features thereon such as, longitudinal features 198 (e.g., pleats and convex ridges between the pleats), that provide for additional deflection of the rays emitted from the treatment LEDs 156 while also helping to enhance the uniformity of the light incident upon the diffuse zone 168. As shown in FIGS. 20 and 21, the features may comprise a plurality of longitudinal pleats 198 forming generally inwardly facing ridges between adjacent pairs of pleats. The pleats and/or ridges 198 may act as cylindrical reflectors to thereby provide multiple virtual sources (i.e., reflections of the LED source(s)) and thus enhancing uniformity in the emitted light. In this manner, non-uniform LEDs may be employed with the distribution of light on the diffuse zone being made substantially uniform via, in part, the features 198 on the surface of the lumen of the optical tube 162. With reference to FIGS. 22 and 23, in one embodiment, the pleats may taper (i.e., become less severe) towards the top end of the optical tube 162 so that the top end of the optical tube 162 may have a circular (or at least a generally circulate) cross section.

The features 198 of the optical tube may be formed through the molding process, or by extensions molded into the inner shell 120 that deform the optical tube, or created by impressing the features on a reflective material that is inserted inside the optical tube 162 (and, optionally, affixed to the optical tube).

In use, the optical tube 162 can act to provide a common light manifold for the facilitation of multiple treatment LEDs 156 (e.g., three LEDs), so that a uniform light distribution can be achieved with multiple wavelength light sources situated at the base of the light tube.

The proximity sensor 140 (also referred to as the “face sensor”) may be coupled to an exterior of the optical tube 162 towards the top end of the tube 162. The inner shell 120 of the upper housing 114 may include a second opening 172 to which the proximity sensor 140 can be positioned adjacent so that IR signals emitted and/or received by the proximity sensor 140 can pass through the second opening. The outer shell 124 of the upper housing 114 helps to keep the area near the proximity sensor 140 clear for repeatable operation of the dermal apparatus 100.

In one embodiment, the vibrating motor 142 may be located below the proximity sensor 140 and can be coupled to the outside of the optical tube 162 as well.

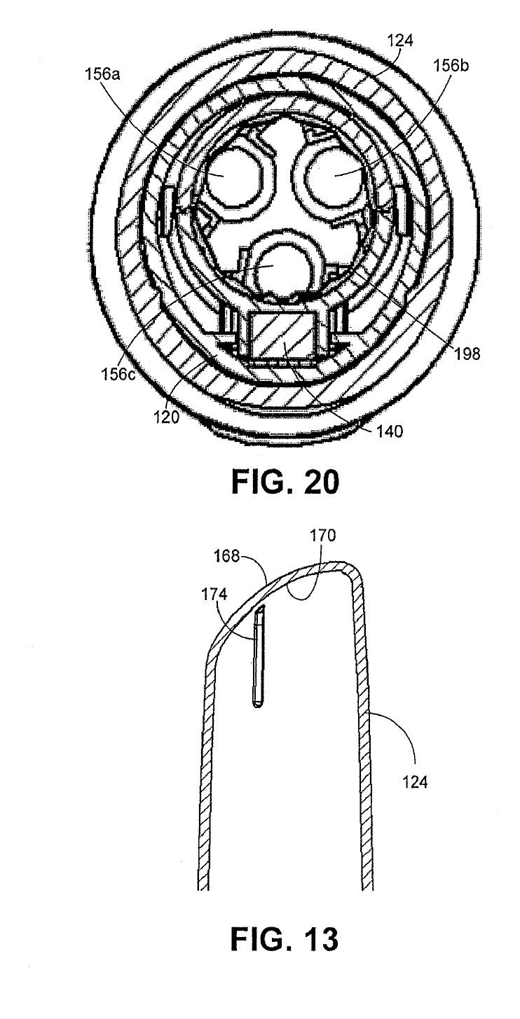

With reference to FIGS. 12 and 13, the outer shell 124 of the upper housing 114 may include one or more treatment guides 174, 176 formed along the interior surface of the outer shell 124. In an preferred embodiment, the outer shell 124 has two treatment guides 174, 176 that extend from the angled tip 102 (starting approximately at the rounded peripheral edges around the angled tip 102 and extending downwards parallel to the longitudinal axis of the dermal apparatus 100 and/or optical tube 162. In use, the treatment guides 174, 176 can be illuminated from light from the treatment light sources 156 that is refracted through the output window/angled tip 102. When illuminated, the treatment guides 174, 176 are illuminated in the same color that is being output by the treatment light sources 156 currently being illuminated/activated to thereby provide a colored visual indication to a user of the particular light treatment presenting being emitted by the dermal device 100. The treatment guides 174, 176 also provide a visual aid to a user for properly aiming or positioning the optical end 102 of the dermal apparatus 100 on the area of the skin to be treated based on the position of the treatment guides 174, 176 to the treated skin area.

In the case of IR treatment LEDs, a small amount of a visible light colored treatment LED (or some other auxiliary LED) may be activated to provide illumination of the guide features.

In an exemplary embodiment, the dermal apparatus 100 may be designed to be eye-safe and comply with the IEC60825 standard. In addition, the output may also have a sufficiently uniform and diffuse output over the emissions surface in order to meet the requirements for a Class I laser device according to the IEC60825 standard.

### Charging Base

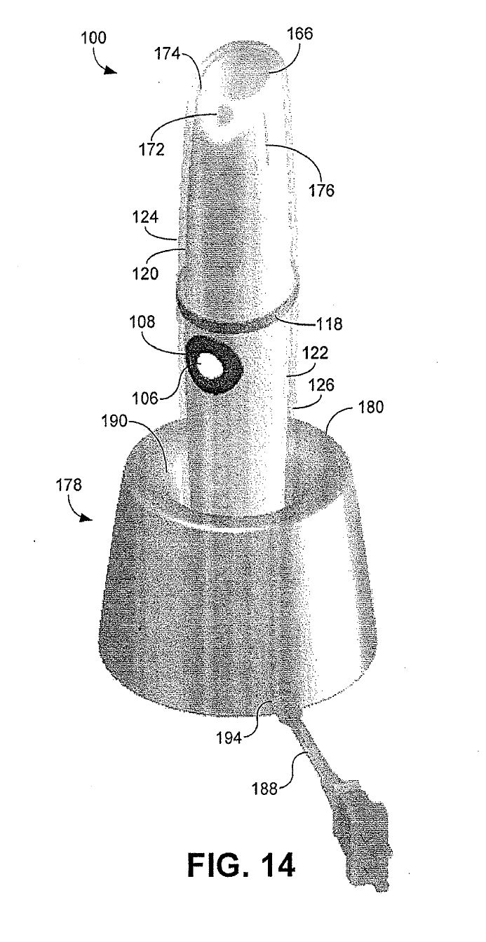

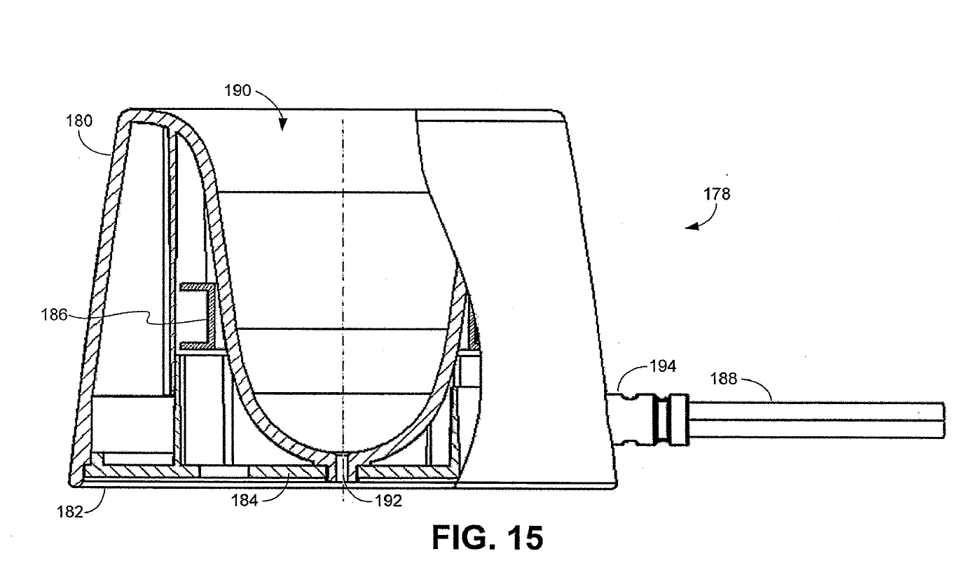

As shown in FIG. 14, embodiments of the dermal apparatus 100 may be provided with a charging base 178. As depicted in FIG. 15, an exemplary embodiment of a charging base 178 may include a top cover 180, a base plate 182, a PCB assembly 184, an inductive charging coil 186 and a power cord 188.

As best shown in FIG. 15, a top face of the top cover 180 of the changing base may include a cup-shaped cavity 190 for receiving an end (e.g.. the bottom end 104) of a dermal apparatus 100 inserted therein. When inserted into the cavity 190, the dermal apparatus may extend in a generally vertical orientation from the charging base 178. In one embodiment, the side wall of the cavity 190 may be angled from a vertical axis so that the dermal apparatus 100 leans against a side of cavity and is skewed an acute angle from a vertical axis extending from a center of the cavity 190.

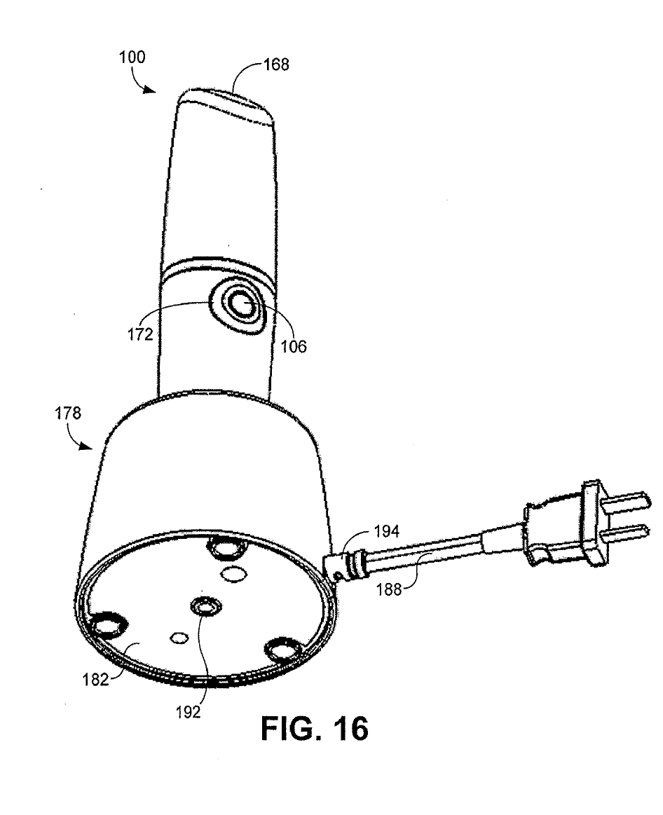

In one embodiment, the cavity 190 may have one or more small drainage holes 192 (see FIG. 16) extending from the bottom of the charging base 178 to permitting any fluid that may happen to get into the cavity to flow through the base plate 182 (and past the electronics inside the charging base) out of the charging base 178 and on to a surface on which the charging base 178 rests such as, for example, a countertop.

On an exterior side of top cover 180, a mount may be included for mounting a strain relief feature 194 of the power cord 188.

The base plate 182 may cover the bottom of the charging base 178 to enclose potted electronics (e.g., on PCB 184) and inductive coil 186 located inside the charger base 178. In one embodiment, labeling relating to the dermal apparatus 100 and/or the charging base 178 may be affixed to a bottom side of the base plate 182.

The PCB assembly 184 may contain circuitry for converting conventional household current into a magnetic field for inductively recharging the dermal apparatus 100. An annular charging coil 186 may be coupled to the PCB assembly 184. The PCB assembly 184 may be mounted on the base plate 182 so that the charging coil 186 extends around the side wall of the cavity 190 in the top cover 180 when the charging coil 186 and PCB assembly 184 are in the charging base 178. The PCB assembly 184 and the charging coil 186 can also be potted in the top cover 180 prior to the installing the base plate 182.

The power cord 188 may be coupled to the PCB assembly 184 to connect the PCB assembly 194, its components and the charging coil 186 to an electrical power supply. In one embodiment, a molded-on strain relief feature 194 may be provided towards the end of the power cord 188 that is coupled to the PCB assembly 184. This strain relief feature 194 may be mounted to the mount on the exterior side of the top cover 180. This strain relief feature 194 may provide additional strength to the coupling of the power cord 188 to the rest of the charging base 178 to help prevent the power cord 188 from separating from the remainder of the charging base 178 through ordinary wear and tear from use of the charging base 178.

FIG. 17 depicts an illustrative circuit for the charging base 178. As mentioned previously, the charging base 178 may be connected to an electrical power supply via the power cord 188. The control circuitry 196 included in the circuit may receive the input line voltage to provide a current to the charging coil 186 in order to provide an inductive trickle charge to the receiving coil 148 in the dermal apparatus 100 when the bottom end 104 of the apparatus 100 is inserted into the cavity 190 of the top cover of the charging base.

### Charging

The battery power supply 144 of the dermal apparatus 100 can be recharged through induction when placed in the charging base 178. As previously mentioned, the charging base 178 can supply a trickle charge to the battery power supply 144 of the dermal apparatus 100. In one embodiment, the battery power supply 144 of the dermal apparatus may comprise three internal NiMH AAA batteries. As an additional feature, an indicator LED of the treatment indicator 108 on the side of the dermal apparatus 100 can be configured so that it slow pulses during the recharging cycle in order to provide a visual indication that the dermal apparatus 100 is charging. Once the dermal apparatus 100 has reached a full charge, the microprocessor 150 of the dermal apparatus 100 can interrupt the flow of current and stop the indicator LED of the treatment indicator 108 from pulsing.

### Programming

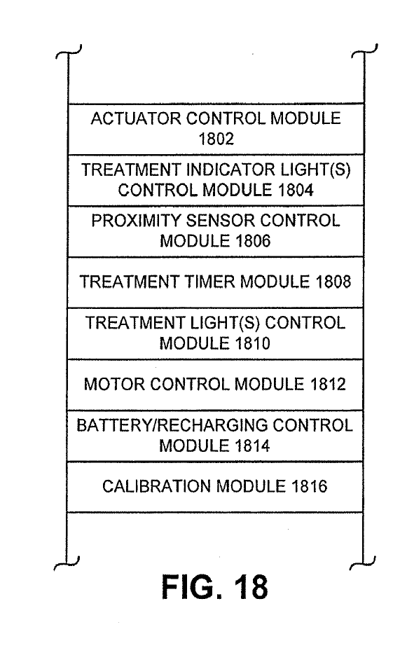

The processor can be programmed to perform a variety of functions. FIG. 18 is an exemplary functional stack identifying the various conceptual modules that may be programmed into the processor 152. For example, the processor 152 may monitor (through actuator control module 1802) the actuation or actuation sequence of the control actuator 106 (e.g., monitor the sequence of button depressions by a user) in order to determine which treatment mode the user is selecting. The processor 152 may also activate an indicator light source(s) 108 (e.g., LEDs) to provide a visual indication of which treatment is about to begin and/or is currently active (e.g., via treatment indicator light control module 1804). The processor 152 can also monitor the face sensor 140 (e.g., via proximity sensor control module 1806), start and stop the countdown treatment timer (e.g., through treatment timer module 1808), activate treatment LEDs 156 and/or the vibrating motor 142 (e.g., through treatment light control module 1810 and motor control module 1812 respectively). As another safety feature, the massaging motor 142 can also act as a light emission indicator for the treatment light source because it may be controlled by the processor 152 to only run when the treatment LEDs 156 are emitting. The processor 152 may also monitor the battery charge state as well as control charging of the battery (e.g., via battery control module 1814). As part of this functionality, the processor 152 may also provide a visual indication of the charging process (e.g., by causing the treatment indicator light to pulsate). The processor 152 may also drive a charging indicator that indicates when the battery is being charged (also through battery control module 1814 for example).

### Calibration

In one embodiment, the processor 152 may have a calibration mode (e.g., calibration module 1816) to set the output power of the dermal apparatus 100. When in such a calibration mode, the processor 152 can accept calibration signals detected through an infrared (IR) detector included in the proximity sensor 140. During calibration mode, the dermal apparatus 100 is operated so that the output power of the dermal apparatus 100 is monitored. The signals received by the IR detector of the proximity sensor 140 allow the processor 152 to adjust the current to the LEDs (either increasing or decreasing the current) until a specified output power is achieved. The value of adjusted current can then be stored in the processor's memory 154 for retrieval during subsequent uses of the dermal apparatus 100. In one implementation, calibration of the dermal apparatus may be performed during the manufacturing process.

### Treatment Programming/Control

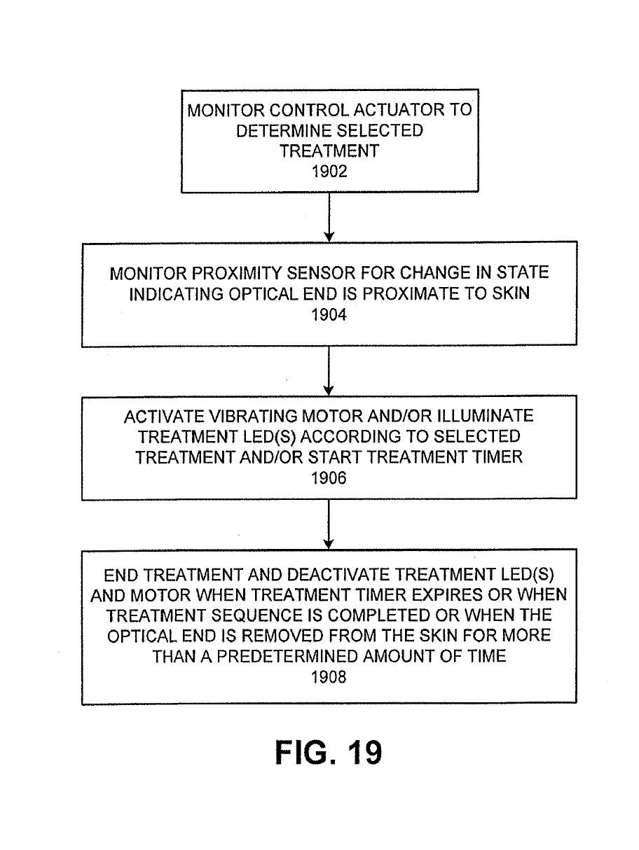

FIG. 19 is a flowchart of an exemplary treatment process that may be carried out using a dermal apparatus in accordance with an exemplary embodiment.

When a user actuates the control actuator 106, the processor 152 can monitor the actuation or actuation sequence performed by the user using the control actuator 106 (e.g., via actuator control module 1802) to determine the particular type of treatment (or sequence of treatments) desired by the user (see operation 1902).

The processor 152 lights up a treatment indicator 108 to provide feedback indicator to a user to identify which treatment has been selected (e.g., via treatment indicator light control module 1804).

With reference to operation 1904, once the desired treatment is selected, the processor looks for a state change in the proximity sensor 140 (e.g., via proximity switch control module 1806). When the optical end of the dermal apparatus is placed on the skin, the state of the proximity sensor 140 changes.

Once a change in state of the proximity sensor 140 is detected, the processor 152 activates the vibrating motor 142 to provide a massaging motion to the dermal apparatus 100 and the predetermined treatment LED are activated (e.g., via motor control module 1812 and treatment light source control module 1810 respectively). The treatment timer may also be activated at this time (e.g., via timer module 1808). See operations 1906. The proximity sensor helps provide an extra level of safety by requiring the dermal apparatus to be placed against a surface in order to activate the treatment LEDs. This feature helps to further mitigate any inadvertent, unpleasant exposure.

As previously mentioned, the treatment LEDs 156 may be configured in at least two ways: a configuration that includes LEDs that emit infrared and red light configuration for providing a skin revitalizing treatment and a blue- and red light configuration for treating acne. The sequence and duration of each treatment color is carried out according to the programming of the processor.

With reference to operation 1910, treatment may end when the treatment sequence is completed or when treatment timer expires or when the dermal apparatus is removed from the skin. In one embodiment, if the treatment is interrupted prematurely, it can be continued by replacing the device on the skin within a few minutes (otherwise the treatment times-out and the device turns itself off).

In one embodiment, the proximity sensor may take readings between pulses of the treatment lights. For example, in one illustrative scheme, sensor readings may take place as follows (in such an embodiment, the proximity sensor may comprise a sensor light source (i.e., a sensor LED) that emits a sensing light and a detector sensor that detects whether there is any reflected light from the sensor light source (e.g., from the sensor light reflecting off of a nearby skin surface):
(1) If a treatment light source/LED is on, turn it off;
(2) Measure the detector voltage relative to VBATT;
(3) Turn on the sensor LED;
(4) Wait for 100 μsec;
(5) Measure the detector voltage;
(6) Turn off the sensor LED;
(7) Compare the difference between dark and illuminated readings to threshold; and
(8) Enable the treatment LED if the threshold is exceeded.

### This process may be repeated every 250 msec during a treatment mode.

### Treatments

In accordance with an illustrative embodiment, a typical treatment schedule can comprise one application for each side of the face twice a day: for example, one treatment in the morning and another treatment in the evening. The light colors for treatment can even alternate daily between infrared (IR) and red light for a skin revitalizing treatment and red and blue light for an acne treatment.

In an exemplary treatment process, a user may apply a thin film of a coupling gel to the area of the user's skin to be treated. The coupling gel helps ensure an optimal delivery of light to the skin by reducing the amount of light lost due to reflection between the skin and the optical end of the dermal apparatus. The user may then remove the dermal apparatus from the charging base to prepare it for the light treatment.

The user may then depress or actuate the control button on the exterior of the dermal apparatus in order to turn on the dermal apparatus and prepare it for operation. Successive depressions of the button can rotate the device through a plurality of states including for example:
State 1 Irradiation using a first wavelength (e.g., a red light treatment—for both revitalizer and acne) for a first predetermined duration;
State 2: Irradiation using a second wavelength (e.g., a IR light for a revitalizing treatment or a blue light for an acne treatment) for a second predetermined duration; and
State 3: Deactivate (i.e., turn off) the dermal apparatus 100.

Each state may be indicated by the color of light concurrently being emitted from the treatment indicator ring 108 that surrounds the control button 106. In one embodiment, the light from the indicator ring 108 may pulse in the given color to indicate that the dermal apparatus 100 is ready to begin a specific light treatment. An illustrative relationship between the color of light emitted from the indicator ring 108 and the color/wavelength of the skin treatment (provided by treatment light sources 156) may comprise:
(1) A red light from the indicator ring 108 may indicate that a red light treatment is to be and/or is presently being output by the treatment light source(s) of the optical assembly;
(2) A blue light from the indicator ring 108 may indicate that a blue light treatment is to be and/or is presently being output by the treatment light source(s) of the optical assembly; and
(3) A yellow light from the indicator ring 108 may indicate that an infrared light treatment is to be and/or is presently being output by the treatment light source(s) of the optical assembly.

Once the treatment color is selected, the dermal apparatus's light emitting end may be placed on the area of skin to be treated (the “treatment area”). When the proximity sensor detects that the light emitting end of the dermal apparatus is contact treatment area, the processor can activate the treatment LED and the vibrating motion to shine the treatment light on the treatment area and to vibrate the dermal apparatus in order to massage the treatment area.

In one embodiment, light internally reflecting from the optical area can illuminate the treatment area guide(s) that are located on the side of the dermal apparatus. These guides may be used to define the emitting and proximity sensor areas and to help the user more accurately position the emitting area on the treatment area.

The treatment may continue until the treatment timer times out or the dermal apparatus is removed from the treatment area and/or if the treatment sequence is completed. If the dermal apparatus is removed from the treatment area before the treatment timer expires and is not replaced within a predefined amount of time (e.g., five minutes) or returned to charger base, the dermal apparatus may be configured to deactivate itself and prevented from emitting light.

In accordance with an exemplary treatment process, a user wishing to perform a light treatment using an embodiment of the apparatus 100 may begin by selecting the light “color” of the first light treatment using, for example, the control actuator 106. For example, in an acne treatment embodiment, a user may begin by selecting either the red or blue colored light for the first light treatment. Similarly, the rejuvenator treatment, the user may select either the red colored light or the infrared light to begin the treatment. In either situation, the user may then apply the optical end of the apparatus 100 to the skin area to begin the treatment process for the selected light color as described above. As previously mentioned, this first treatment using the first selected light color may last up to five minutes in one embodiment. After the first treatment has been completed, the user may then wait for a predetermined amount of time before beginning the treatment in the second light color of the treatment sequence. In one embodiment, the predetermined amount of time between light treatments may be approximately 24 hours (i.e., one treatment per day). In another embodiment, the treatments may be performed twice a day with one treatment in the morning and then a second treatment in the evening. When the predetermined amount of time has elapsed, the user may then select the light color for the second light treatment. Typically, the light color of this treatment should be different than that of the previous treatment. For instance, continuing with the present scenario, if the user first selected a red colored light (in either treatment—acne or revitalizer), then the light color for the second treatment would be blue in the acne treatment and infrared in the revitalizer treatment. The user would then apply the second color of light to the treatment area for the treatment time. This process may then continue with subsequent treatments, again alternating the treatments between the different light colors.

While various embodiments have been described above, it should be understood that they have been presented by way of example only, and not limitation. Thus, the breadth and scope of any embodiment should not be limited by any of the above described exemplary embodiments, but should be defined only in accordance with the following claims and their equivalents.

What is claimed:

1. An apparatus, comprising:
a housing having a window;
a proximity sensor for detecting when a target surface is proximate the window; and
at least one light source located inside the housing, the light source being activated to emit light when the proximity sensor detects that the target surface is proximate the window.

2. The apparatus of claim 1, further comprising a motor for vibrating the housing.

3. The apparatus of claim 1, wherein the housing has at least one treatment guide extending from the window.

4. The apparatus of claim 1, further comprising an actuator located on an exterior of the housing, the actuator permitting selective control of the light source.

5. The apparatus of claim 1, wherein the housing comprises a translucent outer shell.

6. The apparatus of claim 1, wherein the window is translucent.

7. The apparatus of claim 1, further comprising a visual indicator on an exterior of the housing, the visual indicator providing a visual indication of when the light source is activated.

8. The apparatus of claim 7, wherein the visual indicator provides a visual indication of the color of the light being emitted by light source.

9. The apparatus of claim 8, wherein the visual indicator provides a visual indication of the color of the light being emitted by light source before the light source is activated to emit light.

10. The apparatus of claim 1, wherein the light source comprises a plurality of light emitting diodes (LEDs).

11. The apparatus of claim 10, wherein the plurality of LEDs include at least one LED capable of emitting a red light.

12. The apparatus of claim 10, wherein the plurality of LEDs include at least one LED capable of emitting a blue light.

13. The apparatus of claim 10, wherein the plurality of LEDs include at least one LED capable of emitting infrared light.

14. The apparatus of claim 1, further comprising a tube located in the housing, the lumen of the tube providing a passage between the light source and the window.

15. The apparatus of claim 14, wherein the lumen of the tube has a light reflecting surface.

16. The apparatus of claim 1, further comprising a battery power supply contained in the housing.

17. The apparatus of claim 16, further comprising an inductive charging coil for recharging the battery power supply, the inductive charging coil being located in the housing.

18. The apparatus of claim 17, further comprising a charging base having a cavity for receiving a portion of the housing therein, the charging base inductively coupling the inductive charging coil to an external power supply.

19. The apparatus of claim 1, further comprising a heat sink provided in the housing.

20. An apparatus, comprising:
an elongated housing having opposite top and bottom ends;
the housing having an translucent outer shell that defines a translucent window at the top end of the housing capable of permitting passage of light therethrough;
a plurality of light emitting diodes (LEDs) located in the housing;
a tube having a reflective lumen that affords a passage between the window and the LEDs to permit light from the LEDs to pass through the window via the tube;
the outer shell having an elongated indicator guide extending from the translucent window towards the bottom end of the housing;
a motor located in the housing for vibrating the housing when activated;
an actuator on the exterior of the housing, wherein actuation of the actuator controls the activation of the LEDs and the sequence in which the LEDs are activated;
a proximity sensor located in the housing for detecting when the window is proximate a surface, the LEDs being controlled to emit light when the proximity sensor detects a surface within a predefined distance from the window;
a visual indicator adjacent the actuator to provide an visual indication of the selection of the LEDs by the actuator; and
a heat sink located in the housing.
